(19) United States
(12) Patent Application Publication
(10) Pub. No.: US 2011/0093330 A1
(43) Pub. Date: Apr. 21, 2011

(54) PEER VEHICLE ADAPTIVE DESTINATION-BASED MOBILE ADVERTISING

(75) Inventors: Erik J. Burckart, Raleigh, NC (US); Andrew J. Ivory, Wake Forest, NC (US); Aaron K. Shook, Raleigh, NC (US)

(73) Assignee: INTERNATIONAL BUSINESS MACHINES CORPORATION, Armonk, NY (US)

(21) Appl. No.: 12/603,038

(22) Filed: Oct. 21, 2009

(51) Int. Cl. G06Q 30/00; G06F 19/00

(52) U.S. Cl. 705/14.46; 705/14.62; 701/300

(57) ABSTRACT

A destination of a vehicle proximate to an advertising vehicle is determined via an advertising controller associated with the advertising vehicle. An advertisement related to the destination of the proximate vehicle is selected. The selected advertisement is displayed on an external advertising display associated with the advertising vehicle.

### BACKGROUND

The present invention relates to selection and display of mobile advertisements. More particularly, the present invention relates to peer vehicle adaptive destination-based mobile advertising.

Vehicle advertising is generally performed using billboard-style panels attached to an advertising vehicle, such as a bus or taxi cab. The billboard-style panels may be attached to the sides of the advertising vehicle. Additionally, the billboard-style panels may be attached to a frame mounted on top of the advertising vehicle, with a different panel facing in each of several different directions.

### BRIEF SUMMARY

A method includes determining, via an advertising controller associated with an advertising vehicle, a destination of a vehicle proximate to the advertising vehicle; selecting an advertisement related to the destination of the proximate vehicle; and displaying the selected advertisement on an external advertising display associated with the advertising vehicle.

A system includes an external advertising display associated with an advertising vehicle; and an advertising controller configured to: determine a destination of a vehicle proximate to the advertising vehicle; select an advertisement related to the destination of the proximate vehicle; and instruct the external advertising display to display the selected advertisement.

A computer program product includes a computer readable storage medium including a computer readable program. The computer readable program code when executed on a computer causes the computer to: determine a destination of a vehicle proximate to an advertising vehicle; select an advertisement related to the destination of the proximate vehicle; and display the selected advertisement on an external advertising display associated with the advertising vehicle.

### BRIEF DESCRIPTION OF THE SEVERAL VIEWS OF THE DRAWINGS

FIG. 1 is a block diagram of an example of an implementation of a system for peer vehicle adaptive destination-based mobile advertising according to an embodiment of the present subject matter;

FIG. 2 is a block diagram of an example of an implementation of an advertising controller that is capable of performing peer vehicle adaptive destination-based mobile advertising according to an embodiment of the present subject matter;

FIG. 3 is a flow chart of an example of an implementation of a process for automated peer vehicle adaptive destination-based mobile advertising according to an embodiment of the present subject matter; and

FIG. 4 is a flow chart of an example of an implementation of a process for automated peer vehicle adaptive destination-based mobile advertising according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides peer vehicle adaptive destination-based mobile advertising. An advertising controller associated with an advertising vehicle determines a destination of a vehicle proximate to the advertising vehicle. The advertising controller determines the destination of the proximate vehicle by wireless communication with a compatible advertising or other controller associated with the proximate vehicle or associated with the destination, and may be based upon positional data associated with the destination of the proximate vehicle, such as global positioning system (GPS) coordinates, an address, or other indicia associated with the destination. The advertising controller selects an advertisement related to the destination of the proximate vehicle. For example, the selected advertisement may be associated with a place of business, an activity, or another advertising purpose that is located at or near the destination. The advertising controller displays the selected advertisement on an external advertising display associated with the advertising vehicle. By selecting and displaying advertising associated with the destination of the proximate vehicle, advertising presented on the advertising display panel(s) may be targeted to the destination of the occupants of the proximate vehicle.

For purposes of the present subject matter, an advertising vehicle may include, for example, a public transportation vehicle such as a bus, a taxi cab, a commuter train, or other vehicle from which advertising may be displayed. It is noted that the target of the displayed advertising is a passenger of the proximate vehicle rather than a driver. As such, while not to be construed as limiting, the present subject matter may be particularly applicable to public transportation fleet vehicles of the above-referenced categories where drivers are hired to drive the advertising vehicle and the proximate vehicle to promote safety on roadways and travel lanes.

One or more advertising displays may be associated with the advertising vehicle and may be controlled independently by the advertising controller to display one or more advertisements associated with the destination of the proximate vehicle. As such, where a proximate vehicle is situated relative to the advertising vehicle such that an occupant of the proximate vehicle may be able to view multiple displays, multiple advertisements may be selected. In such a situation, the destination of the proximate vehicle may be associated with one or more businesses (e.g., multiple restaurants within a downtown building). Advertising may be selected to enhance the advertising opportunity of one such business, or may be selected to advertise more than one such business. A separate advertisement, either for a single business or for multiple businesses, may be displayed on each of the multiple displays that may be viewable by the occupant of the proximate vehicle.

With respect to advertisement selection for a situation where multiple businesses are associated with a general destination of the proximate vehicle, a revenue value may be associated with an advertisement associated with each business. The advertising controller may determine this associated revenue value. The advertising controller may select one or more of the associated advertisements with a highest revenue value or highest combination of revenue values. Advertisements may be periodically changed and a static or a changing group of selected advertisements may be iteratively shown and/or changed to further enhance revenue potential for the advertising vehicle and businesses associated with the destination of the proximate vehicle.

Further, multiple advertising displays may be oriented in different viewing directions relative to the advertising vehicle, such as via a frame on top of a taxi cab, with two or more advertising displays each facing a different direction. Where multiple displays are oriented in different directions, advertisements viewable by multiple proximate vehicles oriented relative to different displays may be targeted to destinations of occupants of each of the respective vehicles. As such, where multiple advertising displays are viewable by occupants of multiple proximate vehicles, a different advertisement associated with the destination of the respective proximate vehicles may be displayed on the advertising display viewable by the occupant(s) of the respective proximate vehicles.

Additionally, where multiple proximate vehicles may view a particular display associated with the advertising vehicle, the advertising controller may determine a majority destination associated with a majority of the multiple proximate vehicles. The advertising controller may select an advertisement for display on that particular display based upon the determined majority destination.

The advertising controller may further determine a distance from the advertising vehicle to one or more proximate vehicles. The advertising controller may adjust a selected advertisement for at least one of a displayed portion of the advertisement and a displayed size for the advertisement based upon the determined distance from the advertising vehicle to the proximate vehicle. The advertising controller may determine the distance from the advertising vehicle to the proximate vehicle, for example, by receiving positional data associated with the proximate vehicle. The positional data may include, for example, data such as GPS coordinates of the proximate vehicle, coordinates derived by triangulation between multiple wireless communication towers to identify an approximate location of the proximate vehicle, or other positional data as appropriate for a given implementation. The advertising controller may calculate the distance based upon a difference between the positional data (e.g., GPS coordinates of the proximate vehicle and GPS coordinates of the advertising vehicle, triangulation coordinates derived by triangulation between multiple wireless communication towers to identify an approximate location of the proximate vehicle and the advertising vehicle, or other positional data as appropriate for a given implementation). The advertising controller may also and/or alternatively determine the distance from the advertising vehicle to the proximate vehicle by determining a received signal strength associated with signaling received from the proximate vehicle via an inter-vehicle wireless network and calculating the distance based upon the received signal strength.

The advertising controller may also determine a relative speed of the proximate vehicle relative to the advertising vehicle. In such a situation, the advertising controller may adjust a selected advertisement for at least one of a displayed portion of the advertisement and a displayed size for the advertisement based upon the determined relative speed of the proximate vehicle relative to the advertising vehicle.

It should further be noted that either the advertising vehicle or the proximate vehicle may be stationary or moving relative to each other and within proximity of each other. Additionally, the present subject matter may be applied to stationary billboards and advertising displays. In the latter situation, knowledge of the destination of one or more approaching proximate vehicles may be made available earlier relative to the arrival of the proximate vehicle to the respective billboard or advertising display to allow the advertisement to be selected and displayed prior to the arrival of the one or more approaching proximate vehicles.

Many other variations on the present subject matter are possible. Accordingly, all such variations are considered within the scope of the present subject matter.

The peer vehicle adaptive destination-based mobile advertising described herein may be performed in real time to allow prompt selection and display of advertising related to a determined location of a vehicle proximate to an advertising vehicle. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

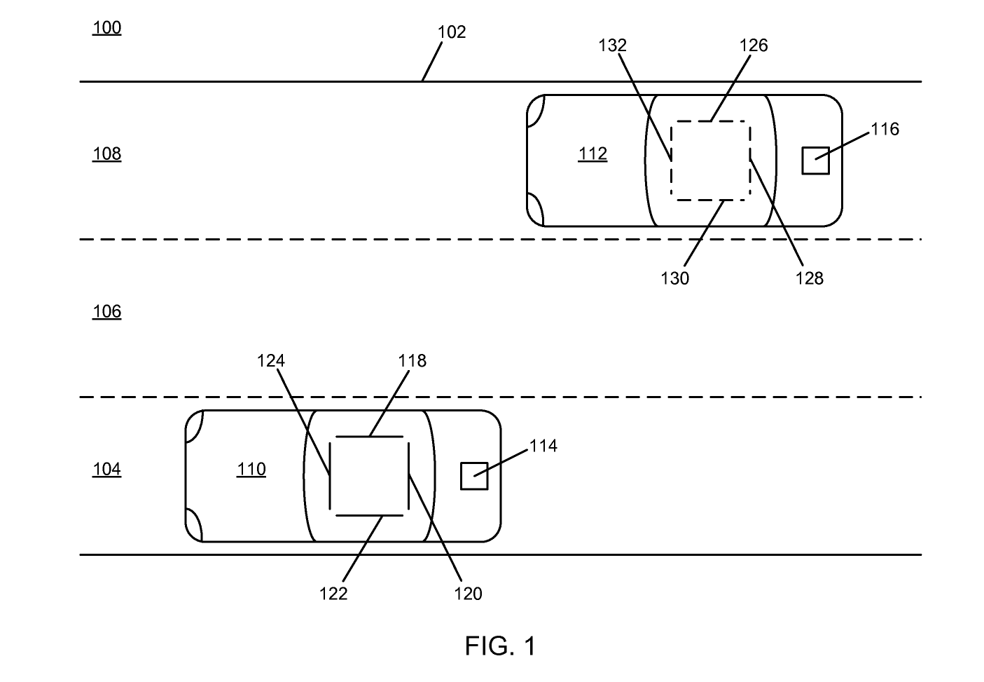

FIG. 1 is a block diagram of an example of an implementation of a system 100 for peer vehicle adaptive destination-based mobile advertising. Within the system 100, a roadway system 102 is illustrated. The roadway system 102 includes lanes 104, 106, and 108. An advertising vehicle 110 is illustrated within the lane 104. A vehicle 112 (hereinafter “proximate vehicle 112”) is shown in proximity of the advertising vehicle 110. An advertising controller 114 is illustrated in association with the advertising vehicle 110. An advertising controller 116 is illustrated in association with the proximate vehicle 112.

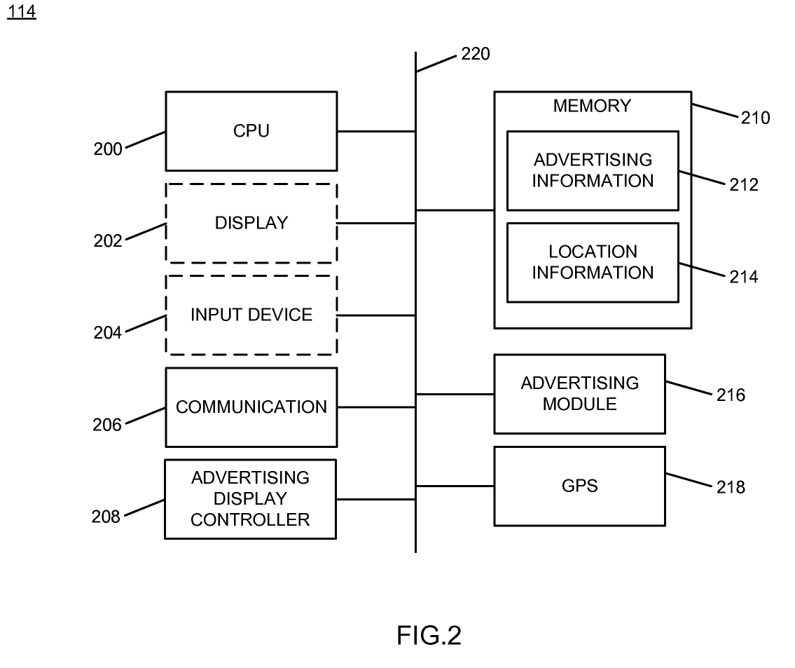

As will be further described in more detail below in association with FIG. 2 through FIG. 4, the advertising controller 114 provides peer vehicle adaptive destination-based mobile advertising within the system 100 by coordination with the advertising controller 116 of the proximate vehicle 112. The advertising controller 116 may provide similar advertising control based upon a destination of the advertising vehicle 110. For ease of illustration, focus within the description below shall be directed to functionality associated with the advertising controller 114 with the understanding that such description applies at least equally to the advertising controller 116. The advertising controller 114 and the advertising controller 116 provide inter-vehicle communication, location determination, destination determination, and other functionality, as described above and in more detail below. The inter-vehicle communication may be made via any suitable wireless network for a given implementation. For example, cellular, Bluetooth® (a registered trademark of Bluetooth SIG, Inc.), and other wireless communication platforms may be used. Additionally, GPS location may be used for vehicle location identification and destination location identification, as described in more detail below. Further, triangulation between multiple communication towers may be used for location identification of the respective vehicles without departure from the scope of the present subject matter. For ease of illustration purposes, wireless communication towers, satellites, and other communication devices have not been shown.

However, it is understood that there are many ways to implement communications and processing as appropriate for a given implementation of the present subject matter. For example, for a cellular communication implementation, communication modules, as described in more detail below, associated with the respective vehicles may be configured to originate and receive cellular telephone calls to open a communication channel for communication purposes. Additionally, if bandwidth and cost permit, public transportation vehicles may maintain active cellular connections for such communication processing. Further, public transportation vehicles may be equipped with two-way radios for communication with a central device associated with administrative personnel in a central office. In such a situation, communications may be implemented using these two-way radio communication channels associated with such a central device. The central device may operate as a master controller for the respective communication modules or may operate as a pass-through controller to relay messages between the respective communication modules.

Alternatively, for a Bluetooth® (a registered trademark of Bluetooth SIG, Inc.) implementation or other direct wireless communication implementation, communication modules, as described in more detail below, associated with the respective vehicles may be configured to send polling or beacon signals to attempt to locate other communication modules associated with other vehicles to open a communication channel for communication purposes.

A variety of protocols for implementation of communications between the respective modules, such as network-style communications, may be used. For example, custom or proprietary communication stacks may be implemented for communicating and transferring information. Alternatively, open standards-based communication stacks may be implemented. Many other possibilities exist for implementation of the present subject matter and for implementation of the described communications and processing. Accordingly, all such possibilities are considered within the scope of the present subject matter.

The advertising vehicle 110 within the present example includes an advertising display 118, an advertising display 120, an advertising display 122, and an advertising display 124. As such, different advertisements may be displayed on each of the advertising displays 118 through 124 depending upon locations of proximate vehicles, such as the proximate vehicle 112, relative to the advertising vehicle 110. Additionally, more than one advertisement may be displayed on each of the advertising displays 118 through 124 without departure from the scope of the present subject matter. It should also be noted, that while the present example shows four advertising displays, this should not be considered limiting. One, two, three, four, or more advertising displays may be associated with an advertising vehicle, such as the advertising vehicle 110.

The proximate vehicle 112 also includes an advertising display 126, an advertising display 128, an advertising display 130, and an advertising display 132. The advertising displays 126 through 132 are illustrated with a dashed-line representation within FIG. 1 to show that they are not required elements. As such, the proximate vehicle 112 may be equipped with the advertising controller 116 without the proximate vehicle 112 displaying advertising. It should also be noted that, while the present example implementation of the system 100 includes the advertising controller 116 of the proximate vehicle 112, this should not be considered limiting. The processing described may be performed by the advertising controller 114 in conjunction with a different device associated with the proximate vehicle 112 that provides destination information for the proximate vehicle 112 without including functionality for advertising. As such, for example, a device that includes a GPS unit capable of deriving coordinate and/or location information regarding a destination of the proximate vehicle 112, and that includes capabilities for sending that information to the advertising vehicle 110, may provide a threshold of functionality sufficient to allow the advertising vehicle 110 to select and display an advertisement associated with the destination.

The advertising displays 118 through 124 and the advertising displays 126 through 132 may include any display device, such as a cathode ray tube (CRT), liquid crystal display (LCD), light emitting diode (LED), projection, or other display element or panel. The advertising displays 118 through 124 and the advertising displays 126 through 132 may also include mechanically-controlled advertising display panels that include striped portions including two or more sides that are turned periodically and in coordination with one another to display different advertisements. Accordingly, the advertising displays 118 through 124 and the advertising displays 126 through 132 may include any form of advertising display technology suitable for a given implementation.

It should be noted that the advertising controller 114 (and the advertising controller 116) may be a portable computing device, either by a user's ability to move the advertising controller 114 to different locations, or by the advertising controller 114's association with a portable platform, such as a plane, train, automobile, or other moving vehicle. It should also be noted that the advertising controller 114 may be any computing device capable of processing information as described above and in more detail below. For example, the advertising controller 114 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below.

As described above, for purposes of the present subject matter, the advertising vehicle 110 may include, for example, a public transportation vehicle such as a bus, a taxi cab, a commuter train, or other vehicle from which advertising may be displayed. It is noted that the target of the displayed advertising is a passenger of the proximate vehicle 112 rather than a driver. As such, while not to be construed as limiting, the present subject matter may be particularly applicable to public transportation fleet vehicles of the above-referenced categories where drivers are hired to drive the advertising vehicle 110 and the proximate vehicle 112 to promote safety on roadways and travel lanes.

FIG. 2 is a block diagram of an example of an implementation of the advertising controller 114 that is capable of performing peer vehicle adaptive destination-based mobile advertising. A central processing unit (CPU) 200 provides computer instruction execution, computation, and other capabilities within the advertising controller 114. A display 202 provides visual information to a user of the advertising controller 114 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202.

It should be noted that the display 202 and the input device 204 are illustrated with a dashed-line representation within FIG. 2 to indicate that they may be optional components for the advertising controller 114 for certain implementations. Accordingly, the advertising controller 114 may operate as a completely automated embedded device without user configurability or feedback. In such an implementation, communications may be received, as described below to control output and input functionality for the advertising controller 114. However, the advertising controller 114 may also provide user feedback and configurability via the display 202 and the input device 204, respectively.

A communication module 206 provides interconnection capabilities that allow the advertising controller 114 to communicate with other modules within the system 100, such as the advertising controller 116, to retrieve destination and location information for the proximate vehicle 112. The communication module 206 may include any electrical, protocol, and protocol conversion capabilities useable to provide the interconnection capabilities.

An advertising display controller 208 interfaces with the advertising displays 118 through 124 to generate output of advertisements via the respective advertising displays. Each of the advertising displays 118 through 124 may be driven independently by the advertising display controller 208, as described above and in more detail below.

A memory 210 includes an advertising information storage area 212 that stores advertising information for display by the advertising controller 114. As will be described in more detail below, advertising information stored within the advertising information storage area 212 may be used to select and/or render advertisements via the advertising displays 118 through 124. The memory 210 also includes a location information storage area 214. The location information storage area 214 stores information associated with location identification for either the advertising vehicle 110 or the proximate vehicle 112, as described above and in more detail below. The location information storage area 214 also stores destination information for either the advertising vehicle 110 or the proximate vehicle 112.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, a code execution area, and a data area without departure from the scope of the present subject matter.

An advertising module 216 is also illustrated. The advertising module 216 provides advertisement selection and control processing to implement the peer vehicle adaptive destination-based mobile advertising for the advertising controller 114, as described above and in more detail below.

A global positioning system (GPS) module 218 provides positioning location coordinates usable for identifying a physical and/or logical location of the advertising controller 114. The GPS module 218 may also be used to identify a physical and/or logical location for a destination of either the advertising vehicle 110 or the proximate vehicle 112. Location identification information generated by the GPS module 218 may be stored within the location information storage area 214 for use by the advertising module 216.

Though the GPS module 218 is illustrated as a component-level module for ease of illustration and description purposes, it should be noted that the GPS module 218 may include any hardware, programmed processor(s), and memory used to carry out the functions of the GPS module 218 as described above and in more detail below. For example, the GPS module 218 may include additional controller circuitry in the form of application specific integrated circuits (ASICs), processors, antennas, and/or discrete integrated circuits and components for performing communication and electrical control activities associated with the GPS module 218. Additionally, the GPS module 218 may also include interrupt-level, stack-level, and application-level modules as appropriate. Furthermore, the GPS module 218 may include any memory components used for storage, execution, and data processing for performing processing activities associated with the GPS module 218. The GPS module 218 may also form a portion of other circuitry described without departure from the scope of the present subject matter.

Though the communication module 206, the advertising display controller 208, the advertising module 216, and the GPS module 218 are illustrated as component-level modules for ease of illustration and description purposes, it should be noted that the respective modules may include any hardware, programmed processor(s), and memory used to carry out the functions of the respective modules as described above and in more detail below. For example, the communication module 206, the advertising display controller 208, the advertising module 216, and the GPS module 218 may include additional controller circuitry in the form of application specific integrated circuits (ASICs), processors, antennas, and/or discrete integrated circuits and components for performing communication and electrical control activities associated with the respective modules. Additionally, the communication module 206, the advertising display controller 208, the advertising module 216, and the GPS module 218 may include interrupt-level, stack-level, and application-level modules as appropriate. Furthermore, the communication module 206, the advertising display controller 208, the advertising module 216, and the GPS module 218 may include any memory components used for storage, execution, and data processing for performing processing activities associated with the respective modules. The communication module 206, the advertising display controller 208, the advertising module 216, and the GPS module 218 may also form a portion of other circuitry described without departure from the scope of the present subject matter. It is further understood that the advertising display controller 208 may form a portion of the advertising module 216 without departure from the scope of the present subject mtatter,

The CPU 200, the display 202, the input device 204, the communication module 206, the advertising display controller 208, the memory 210, the advertising module 216, and the GPS module 218 are interconnected via an interconnection 220. The interconnection 220 may include a system bus, a network, or any other interconnection capable of providing the respective components with suitable interconnection for the respective purpose.

While the advertising controller 114 is illustrated with and has certain components described, other modules and components may be associated with the advertising controller 114 without departure from the scope of the present subject matter. Additionally, it should be noted that, while the advertising controller 114 is described as a single device for ease of illustration purposes, the components within the advertising controller 114 may be co-located or distributed and interconnected via a network without departure from the scope of the present subject matter. For a distributed arrangement, the display 202 and the input device 204 may be located at a server, kiosk, or other location, while the CPU 200 and memory 210 may be located within the advertising vehicle 110. Many other possible arrangements for components of the advertising controller 114 are possible and all are considered within the scope of the present subject matter. Accordingly, the advertising controller 114 may take many forms and may be associated with many platforms.

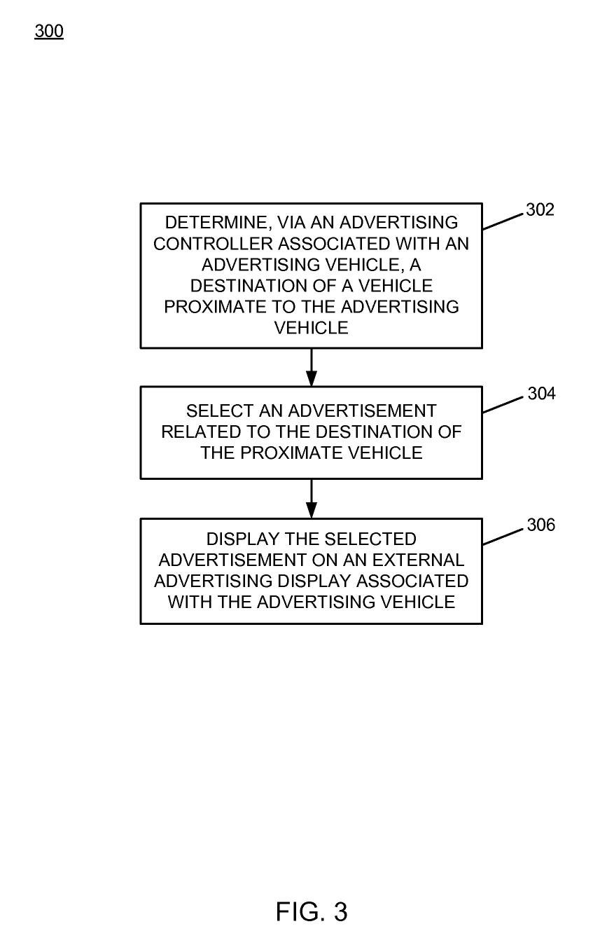

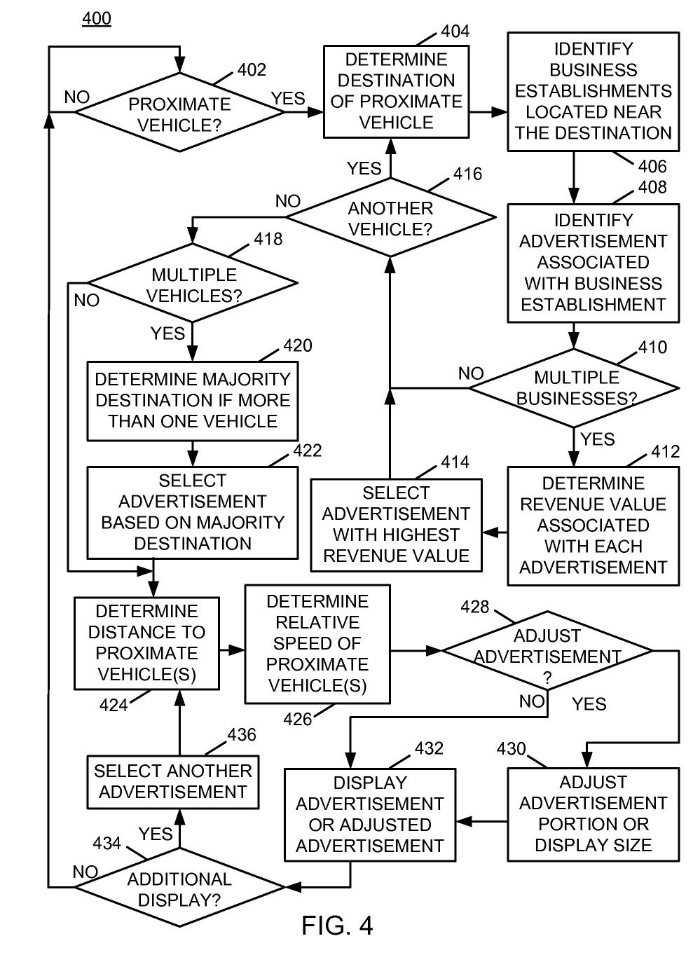

FIG. 3 through FIG. 4 below describe example processes that may be executed by devices, such as the advertising controller 114 to perform the peer vehicle adaptive destination-based mobile advertising associated with the present subject matter. Many other variations on the example processes are possible and all are considered within the scope of the present subject matter. The example processes may be performed by modules, such as the advertising module 216 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for automated peer vehicle adaptive destination-based mobile advertising. At block 302, the process 300 determines, via an advertising controller associated with an advertising vehicle, a destination of a vehicle proximate to the advertising vehicle. At block 304, the process 300 selects an advertisement related to the destination of the proximate vehicle. At block 306, the process 300 displays the selected advertisement on an external advertising display associated with the advertising vehicle.

FIG. 4 is a flow chart of an example of an implementation of a process 400 for automated peer vehicle adaptive destination-based mobile advertising. At decision point 402, the process 400 makes a determination as to whether a vehicle, such as the proximate vehicle 112, is located proximate to the advertising vehicle 110. The process 400 may make the determination that a vehicle is located proximate to the advertising vehicle 110 by use of communication with other modules, such as the advertising controller 116 associated with the proximate vehicle 112. The process 400 may also make the determination that a vehicle is located proximate to the advertising vehicle 110 by signal strength indications identified by the communication module 206 that are generated by other modules, such as the advertising controller 116 associated with the proximate vehicle 112. Many other approaches to determining that a vehicle is proximate to the advertising vehicle 110 are possible and all are considered within the scope of the present subject matter.

When a determination is made that a vehicle is proximate to the advertising vehicle 110, the process 400 determines a destination of the proximate vehicle 112 at block 404. For example, the process 400 may receive, via a wireless connection, global positioning system (GPS) coordinates of the destination from the proximate vehicle 112. The GPS coordinates may be received via the communication module 206 from the advertising controller 116 associated with the proximate vehicle 112. The wireless connection may be a cellular wireless connection, a Bluetooth® (a registered trademark of Bluetooth SIG, Inc.) wireless connection, or another wireless connection.

At block 406, the process 400 identifies one or more business establishments located near the GPS coordinates of the destination. Again, the process 400 may use the GPS coordinates to perform a search within either the location information storage area 214 in the memory 210 or via a networked server (not shown) to identify business establishments near the destination.

At block 408, the process 400 identifies one or more advertisements associated with the identified business establishments. The advertisements may be identified via advertising information stored within the advertising information storage area 212 in the memory 210 or via a networked server (again not shown) to identify advertisements associated with the identified business establishments.

At decision point 410, the process 400 determines whether multiple business establishments with associated advertisements are located near the destination of the proximate vehicle 112. When a determination is made that multiple business establishments with associated advertisements are located near the destination, the process 400 determines a revenue value associated with each of the associated advertisements at block 412. At block 414, the process 400 selects one of the associated advertisements with a highest revenue value.

When a determination is made that multiple business establishments with associated advertisements are not located near the destination at decision point 410, or upon selection of one of the associated advertisements with a highest revenue value, the process 400 makes a determination as to whether another vehicle is located proximate to the advertising vehicle 110 at decision point 416. When a determination is made that another vehicle is located proximate to the advertising vehicle 110, the process 400 returns to block 404 and iterates as described above to determine a destination of the other proximate vehicle and to identify and selects one or more advertisements associated with the destination. As such, the process 400 may determine a destination associated with multiple vehicles located proximate to the advertising vehicle 110.

When a determination is made at decision point 416 that another vehicle is not located proximate to the advertising vehicle 110, the process 400 makes a determination at decision point 418 as to whether multiple vehicles proximate to the advertising vehicle 110 have been previously identified, as described above. When a determination is made that multiple vehicles have been identified proximate to the advertising vehicle 110, the process 400 determines a majority destination associated with a majority of the multiple proximate vehicles at block 420. At block 422, the process 400 selects an advertisement based upon the majority destination associated with the majority of the multiple proximate vehicles.

When a determination is made at decision point 418 that multiple vehicles are not proximate to the advertising vehicle 110, or upon selecting the advertisement based upon the majority destination associated with the majority of the multiple proximate vehicles at block 422, the process 400 determines a distance from the advertising vehicle 110 to the proximate vehicle or the each of the multiple proximate vehicles at block 424. At block 426, the process 400 determines a relative speed of the proximate vehicle(s) relative to the advertising vehicle 110.

For either a determination of distance or relative speed, the process 400 may, for example, receive, via a wireless connection, GPS coordinates of the proximate vehicle(s) and calculate the distance and/or relative speed based upon a difference between the GPS coordinates of the proximate vehicle(s) and GPS coordinates and/or speed of the proximate vehicle 112. The process 400 may further determine a received signal strength associated with signaling received from the proximate vehicle(s) via an inter-vehicle wireless connection and calculate the distance and/or relative speed based upon the received signal strength. The process 400 may further receive speed information from the proximate vehicle(s) via a wireless connection and calculate the relative speed by difference relative to a known speed of the advertising vehicle 110. Many other possibilities exist for determining distance and/or relative speed and all are considered within the scope of the present subject matter. The process 400 may further average multiple distances or use other criteria such as a relative perspective and/or viewing angle of occupants of multiple proximate vehicles to arrive at a processing distance for subsequent processing.

At decision point 428, the process 400 makes a determination as to whether to adjust either a displayed portion of the advertisement or a displayed size of the advertisement based upon the determined distance or average distance from the advertising vehicle to the one or more proximate vehicle(s) and/or the relative speed between the vehicles. When a determination is made to adjust either a displayed portion of the advertisement or a displayed size of the advertisement, the process 400 adjusts the advertisement for at least one of a displayed portion of the advertisement and a displayed size of the advertisement based upon the determined distance or average distance from the advertising vehicle 110 to the one or more proximate vehicle(s) at block 430.

Upon completion of adjustments to the advertisement based upon the determined distance(s) and/or relative speed at block 430 or upon determining at decision point 428 not to adjust the advertisement based upon the determined distance(s) and/or relative speed, the process 400 displays the advertisement or the adjusted advertisement on an external advertising display, such as one of the advertising displays 118 through 124 associated with the advertising vehicle 110 at block 432.

At decision point 434, the process 400 makes a determination as to whether an additional display is available for display of advertising for the destination of one or more of the proximate vehicle(s). For example, the process 400 may determine a location of one or more proximate vehicle(s) relative to the advertising vehicle 110 by use of, for example, GPS coordinates or signal strength. The process 400 may further determine based upon the determined location of the proximate vehicle(s) relative to the advertising vehicle that another external advertising display is viewable by an occupant located within one or more of the proximate vehicle(s). Alternatively, for a second or subsequent iteration of the process 400, the process 400 may determine whether another display is available that does not already have selected advertising displayed.

Additionally, where the process 400 determines a second or additional destination associated with another of the one or more of the proximate vehicle(s), such as a subset of the proximate vehicle(s), the process 400 may select and display advertisements associated with the second or additional destination. For example, where one of the advertising displays is viewable by occupants of a subset (e.g., one) of the proximate vehicle(s), and a second of the advertising displays is viewable by occupants of a second subset (e.g., one) of the proximate vehicle(s), the process 400 may display an advertisement associated with the respective destinations to the respective occupants. Many other variations on the present subject matter are possible and all are considered within the scope of the present subject matter.

When a determination is made that an additional display is available for display of advertising for the destination of one or more of the proximate vehicle(s), the process 400 selects another advertisement related to the destination of the proximate vehicle(s) at block 436 and the process returns to block 424 to determine a distance from the advertising vehicle 110 to one or more of the proximate vehicle(s) and iterates as described above. It should however be understood that the transition to block 424 is for ease of illustration purposes. Where the determination that an additional display is available for display of advertising for the destination of one or more of the proximate vehicle(s) is made in relative time proximity to a prior determination of distance and/or relative speed between the vehicles, the process 400 may return to decision point 428 to make the determination as to whether to adjust one of the advertisements for at least one of a displayed portion of the advertisement and a displayed size of the advertisement based upon the determined distance or average distance from the advertising vehicle 110 to the one or more proximate vehicle(s) without departure from the scope of the present subject matter.

Returning to the description of decision point 434, when a determination is made that an additional display is not available for display of advertising for the destination of one or more of the proximate vehicle(s), the process 400 returns to decision point 402 to await detection of another vehicle proximate to the advertising vehicle 110. As such, the process 400 provides peer vehicle adaptive destination-based mobile advertising based upon determination and identification of destinations of vehicles proximate to an advertising vehicle, such as the advertising vehicle 110. The process 400 identifies advertisements associated with businesses or other establishments associated with the determined destinations. The process 400 further selects and adjusts advertisements for distance, relative speed, and other factors relative to an advertising vehicle and a vehicle proximate to the advertising vehicle. Many other possibilities exist for advertising based upon destinations of peer vehicles and all are considered within the scope of the present subject matter.

As described above in association with FIG. 1 through FIG. 4, the example systems and processes provide peer vehicle adaptive destination-based mobile advertising. Many other variations and additional activities associated with peer vehicle adaptive destination-based mobile advertising are possible and all are considered within the scope of the present subject matter.

Those skilled in the art will recognize, upon consideration of the above teachings, that certain of the above examples are based upon use of a programmed processor, such as CPU 200. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above and below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
determining, via an advertising controller associated with an advertising vehicle, a destination of a vehicle proximate to the advertising vehicle;
selecting an advertisement related to the destination of the proximate vehicle; and
displaying the selected advertisement on an external advertising display associated with the advertising vehicle.

2. The method of claim 1, where:
determining, via the advertising controller associated with the advertising vehicle, the destination of the vehicle proximate to the advertising vehicle comprises receiving, via a wireless connection, positional data associated with the destination from the proximate vehicle; and
selecting the advertisement related to the destination of the proximate vehicle comprises:
identifying a business establishment located near a location referenced by the positional data associated with the destination received from the proximate vehicle; and
identifying an advertisement associated with the business establishment.

3. The method of claim 1, where:
determining, via the advertising controller associated with the advertising vehicle, the destination of the vehicle proximate to the advertising vehicle comprises determining a destination associated with a plurality of vehicles proximate to the advertising vehicle; and
selecting the advertisement related to the destination of the proximate vehicle comprises:
determining a majority destination associated with a majority of the plurality of proximate vehicles; and
selecting the advertisement based upon the majority destination associated with the majority of the plurality of proximate vehicles.

4. The method of claim 1, further comprising determining that multiple business establishments with associated advertisements are located near the destination of the proximate vehicle and where selecting the advertisement related to the destination of the proximate vehicle comprises:
determining a revenue value associated with each of the associated advertisements; and
selecting one of the associated advertisements with a highest revenue value.

5. The method of claim 1, further comprising determining a distance from the advertising vehicle to the proximate vehicle and where displaying the selected advertisement on the external advertising display associated with the advertising vehicle comprises:
adjusting the advertisement for at least one of a displayed portion of the advertisement and a displayed size of the advertisement based upon the determined distance from the advertising vehicle to the proximate vehicle; and
displaying the adjusted advertisement on the external advertising display associated with the advertising vehicle.

6. The method of claim 5, where determining the distance from the advertising vehicle to the proximate vehicle comprises at least one of:
receiving, via a wireless connection, positional data associated with the proximate vehicle and calculating the distance based upon a difference between the positional data associated with the proximate vehicle and positional data associated with the advertising vehicle; and
determining a received signal strength associated with signaling received from the proximate vehicle via an inter-vehicle wireless connection and calculating the distance based upon the received signal strength.

7. The method of claim 1, further comprising determining a relative speed of the proximate vehicle relative to the advertising vehicle and where displaying the selected advertisement on the external advertising display associated with the advertising vehicle comprises:
adjusting the advertisement for at least one of a displayed portion of the advertisement and a displayed size of the advertisement based upon the determined relative speed of the proximate vehicle relative to the advertising vehicle; and
displaying the adjusted advertisement on the external advertising display associated with the advertising vehicle.

8. The method of claim 1, where the advertising vehicle comprises a plurality of external advertising displays, the external advertising display comprises a first external advertising display of the plurality of external advertising displays, and the selected advertisement comprises a first selected advertisement, and further comprising:
determining a location of the proximate vehicle relative to the advertising vehicle;
determining, based upon the determined location of the proximate vehicle relative to the advertising vehicle, that a second of the plurality of external advertising displays is viewable by an occupant located within the proximate vehicle;
selecting a second advertisement related to the destination of the proximate vehicle; and
displaying the second selected advertisement on the second of the plurality of external advertising displays.

9. The method of claim 1, where the advertising vehicle comprises a plurality of external advertising displays, the external advertising display comprises a first external advertising display of the plurality of external advertising displays, and the selected advertisement comprises a first selected advertisement; and
where determining, via the advertising controller associated with the advertising vehicle, the destination of the vehicle proximate to the advertising vehicle comprises determining a destination associated with a plurality of vehicles proximate to the advertising vehicle; and
further comprising:
determining a destination of a second of the plurality of vehicles proximate to the advertising vehicle;
selecting a second advertisement related to the destination of the second of the plurality of proximate vehicles; and
displaying the second selected advertisement on a second of the plurality of external advertising displays viewable by the second of the plurality of proximate vehicles.

10. A system, comprising:
an external advertising display associated with an advertising vehicle;
an advertising display controller; and
an advertising controller configured to:
determine a destination of a vehicle proximate to the advertising vehicle;
select an advertisement related to the destination of the proximate vehicle; and
display, via the advertising display controller, the selected advertisement on the external advertising display associated with the advertising vehicle.

11. The system of claim 10, further comprising:
a positional data system; and
where:
in being configured to determine the destination of the vehicle proximate to the advertising vehicle, the advertising controller is configured to receive, via a wireless connection, positional data associated with the destination from the proximate vehicle; and
in being configured to select the advertisement related to the destination of the proximate vehicle, the advertising controller is configured to:
identify a business establishment located near a location referenced by the positional data associated with the destination received from the proximate vehicle; and
identify an advertisement associated with the business establishment.

12. The system of claim 10, where:
in being configured to determine the destination of the vehicle proximate to the advertising vehicle, the advertising controller is configured to determine a destination associated with a plurality of vehicles proximate to the advertising vehicle; and
in being configured to select the advertisement related to the destination of the proximate vehicle, the advertising controller is configured to:
determine a majority destination associated with a majority of the plurality of proximate vehicles; and
select the advertisement based upon the majority destination associated with the majority of the plurality of proximate vehicles.

13. The system of claim 10, where the advertising controller is further configured to determine that multiple business establishments with associated advertisements are located near the destination of the proximate vehicle and where, in being configured to select the advertisement related to the destination of the proximate vehicle, the advertising controller is configured to:
determine a revenue value associated with each of the associated advertisements; and
select one of the associated advertisements with a highest revenue value.

14. The system of claim 10, where the advertising controller is further configured to determine a distance from the advertising vehicle to the proximate vehicle and where, in being configured to instruct the external advertising display to display the selected advertisement, the advertising controller is configured to:
adjust the advertisement for at least one of a displayed portion of the advertisement and a displayed size of the advertisement based upon the determined distance from the advertising vehicle to the proximate vehicle; and
display, via the advertising display controller, the adjusted advertisement on the external advertising display associated with the advertising vehicle.

15. The system of claim 14, further comprising:
a positional data system; and
where, in being configured to determine the distance from the advertising vehicle to the proximate vehicle, the advertising controller is configured to at least one of:
receive, via a wireless connection, positional data associated with the proximate vehicle and calculate the distance based upon a difference between the positional data associated with the proximate vehicle and positional data associated with the advertising vehicle; and
determine a received signal strength associated with signaling received from the proximate vehicle via an inter-vehicle wireless connection and calculate the distance based upon the received signal strength.

16. The system of claim 10, where the advertising controller is further configured to determine a relative speed of the proximate vehicle relative to the advertising vehicle and where, in being configured to instruct the external advertising display to display the selected advertisement, the advertising controller is configured to:
adjust the advertisement for at least one of a displayed portion of the advertisement and a displayed size of the advertisement based upon the determined relative speed of the proximate vehicle relative to the advertising vehicle; and
display, via the advertising display controller, the adjusted advertisement on the external advertising display associated with the advertising vehicle.

17. The system of claim 10, further comprising a plurality of external advertising displays, and where the external advertising display comprises a first external advertising display of the plurality of external advertising displays, and the selected advertisement comprises a first selected advertisement; and
where in being configured to determine the destination of the vehicle proximate to the advertising vehicle, the advertising controller is configured to determine a destination associated with a plurality of vehicles proximate to the advertising vehicle; and
where the advertising controller is further configured to:
determine a destination of a second of the plurality of vehicles proximate to the advertising vehicle;
select a second advertisement related to the destination of the second of the plurality of proximate vehicles; and
display the second selected advertisement on a second of the plurality of external advertising displays viewable by the second of the plurality of proximate vehicles.

18. A computer program product comprising a computer readable storage medium including a computer readable program code, wherein the computer readable program code when executed on a computer causes the computer to:
determine a destination of a vehicle proximate to an advertising vehicle;
select an advertisement related to the destination of the proximate vehicle; and
display the selected advertisement on an external advertising display associated with the advertising vehicle.

19. The computer program product of claim 18, where:
in causing the computer to determine the destination of the vehicle proximate to the advertising vehicle, the computer readable program when executed on the computer causes the computer to receive, via a wireless connection, positional data associated with the destination from the proximate vehicle; and
in causing the computer to select the advertisement related to the destination of the proximate vehicle, the computer readable program when executed on the computer causes the computer to:
identify a business establishment located near a location referenced by the positional data associated with the destination received from the proximate vehicle; and
identify an advertisement associated with the business establishment.

20. The computer program product of claim 18, where:
in causing the computer to determine the destination of the vehicle proximate to the advertising vehicle, the computer readable program when executed on the computer causes the computer to determine a destination associated with a plurality of vehicles proximate to the advertising vehicle; and
in causing the computer to select the advertisement related to the destination of the proximate vehicle, the computer readable program when executed on the computer causes the computer to:
determine a majority destination associated with a majority of the plurality of proximate vehicles; and
select the advertisement based upon the majority destination associated with the majority of the plurality of proximate vehicles.

21. The computer program product of claim 18, where the computer readable program code when executed on the computer further causes the computer to determine that multiple business establishments with associated advertisements are located near the destination of the proximate vehicle and where, in causing the computer to select the advertisement related to the destination of the proximate vehicle, the computer readable program when executed on the computer causes the computer to:
determine a revenue value associated with each of the associated advertisements; and
select one of the associated advertisements with a highest revenue value.

22. The computer program product of claim 18, where the computer readable program code when executed on the computer further causes the computer to determine a distance from the advertising vehicle to the proximate vehicle and where, in causing the computer to display the selected advertisement on the external advertising display associated with the advertising vehicle, the computer readable program when executed on the computer causes the computer to:
adjust the advertisement for at least one of a displayed portion of the advertisement and a displayed size of the advertisement based upon the determined distance from the advertising vehicle to the proximate vehicle; and
display the adjusted advertisement on the external advertising display associated with the advertising vehicle.

23. The computer program product of claim 22, where, in causing the computer to determine the distance from the advertising vehicle to the proximate vehicle, the computer readable program when executed on the computer causes the computer to at least one of:
receive, via a wireless connection, positional data associated with the proximate vehicle and calculate the distance based upon a difference between the positional data associated with the proximate vehicle and positional data associated with the advertising vehicle; and
determine a received signal strength associated with signaling received from the proximate vehicle via an inter-vehicle wireless connection and calculate the distance based upon the received signal strength.

24. The computer program product of claim 18, where the computer readable program code when executed on the computer further causes the computer to determine a relative speed of the proximate vehicle relative to the advertising vehicle and where, in causing the computer to display the selected advertisement on the external advertising display associated with the advertising vehicle, the computer readable program when executed on the computer causes the computer to:
adjust the advertisement for at least one of a displayed portion of the advertisement and a displayed size of the advertisement based upon the determined relative speed of the proximate vehicle relative to the advertising vehicle; and
display the adjusted advertisement on the external advertising display associated with the advertising vehicle.

25. The computer program product of claim 18, where the advertising vehicle comprises a plurality of external advertising displays, and where the external advertising display comprises a first external advertising display of the plurality of external advertising displays, and the selected advertisement comprises a first selected advertisement; and
where in causing the computer to determine the destination of the vehicle proximate to the advertising vehicle, the computer readable program when executed on the computer causes the computer to determine a destination associated with a plurality of vehicles proximate to the advertising vehicle; and
where the computer readable program when executed on the computer further causes the computer to:
determine a destination of a second of the plurality of vehicles proximate to the advertising vehicle;
select a second advertisement related to the destination of the second of the plurality of proximate vehicles; and
display the second selected advertisement on a second of the plurality of external advertising displays viewable by the second of the plurality of proximate vehicles.
